(19) United States
(12) Patent Application Publication
(10) Pub. No.: US 2006/0137540 A1
(43) Pub. Date: Jun. 29, 2006

(54) Device and procedure for discharging a cooking liquid from a food product cooking apparatus

(76) Inventor: Giuseppe De' Longhi, Treviso (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/531,886

(22) PCT Filed: Oct. 6, 2003
(86) PCT No.: PCT/EP03/11026

§ 371 Date: Apr. 15, 2005

(30) Foreign Application Priority Data
Oct. 18, 2002 (IT) MI2002A002212

(51) Int. Cl. A47J 37/12

(52) U.S. Cl. 99/403

(57) ABSTRACT

The device for discharging a cooking liquid from a food product cooking apparatus (1) comprises valve means (3) for intercepting the cooking liquid and outside conveyance means of the apparatus. The discharging procedure consists of rotating a substantially rigid tube, connected to the valve means for intercepting liquid, from an upward orientation to a downward orientation, simultaneously and progressively taking the intercepting means from a closed position to an open position, so as to allow the discharge of the liquid through the intercepting means and the tube.

The present invention refers to a device and procedure for discharging a cooking liquid from a food product cooking apparatus.

In particular, hereafter reference shall be made to cooking apparatuses like fryers. It is, however, clear that the same teachings can advantageously be used on similar apparatuses like electrical pasta cooking apparatuses, rice cookers, etc. For some time fryers have been present on the market equipped with an oil containing bowl and a basket which can be inserted in the bowl in which the food products to be fried are to be housed.

As is known, such fryers after a certain number of cooking cycles require the replacement of oil; however, this operation is very laborious since the entire fryer must be tipped up to pour out the oil from the bowl.

It is clear that such an operation can cause numerous drawbacks, amongst which we mention the danger of burning for the user and the staining of the resistance or other electrical parts of the fryer.

To avoid these drawbacks devices have been developed which allow the oil to be tipped out without the fryer needing to be tipped-up or tilted.

Such devices comprise bendable tubes made from flexible rubber equipped with an end cap.

In practice, in rest position these tubes are bent and housed in suitable seats formed in the body of the fryer, whereas in work position the tubes are removed from the bending configuration and the cap is taken away so as to discharge the oil keeping the fryer in flat position.

However, such devices have also presented numerous drawbacks, including the fact that the flexible rubber tubes do not ensure sufficient stability and safety and it is possible that, during the discharge of the oil, due to oscillations or vibrations, prompted for example by their own elasticity or by knocks or displacements of the fryer, the oil falls or splashes out from the container where it is being collected. Moreover, the rubber element, due to the heat and the repeated bending, tends to become damaged through time; the harmful effect of the discharge of oil, which can seep through the slits of the tube, is clear.

Moreover, with conventional fryers it is usually very difficult to adjust the amount of cooking liquid to be discharged and, moreover, sometimes the cap is removed after the tube has been removed and rectified, usually causing inconvenient drips.

The technical task proposed of the present invention is, therefore, that of realising a device and procedure for discharging a cooking liquid from a food product cooking apparatus-which allows the aforementioned technical drawbacks of the prior art to be eliminated.

In this technical task a purpose of the invention is that of realising a discharge device and procedure which are very stable and safe, in particular during the discharge of the cooking liquid.

Another purpose of the invention is that of realising a discharging device which is not subject to damage, due to heat and repeated bending, through time.

A further purpose of the invention is that of realising a discharge device and procedure which allow the discharge of liquid to be partialised and, therefore, to be controlled; in this way it is possible to control the liquid which comes out from the apparatus for example to take it to a certain level in the collection container and/or in the bowl of the apparatus, or else to fill the collection container without making it overflow.

The last but not least purpose of the invention is that of realising a discharging device and procedure which allow the amount of cooking liquid to be discharged to be adjusted and, moreover, which allow inconvenient drips to be prevented. Advantageously, the partialisation is accompanied by the variation of the inclination of the tube.

The technical task, as well as these and other purposes, according to the present invention, are accomplished by realising a device for discharging a cooking liquid from a food product cooking apparatus, characterised in that it comprises valve means for intercepting said cooking liquid and outside conveyance means of said apparatus.

The present finding also refers to a procedure for discharging a cooking liquid from a food product cooking apparatus, characterised in that it consists of rotating a substantially rigid tube, connected to valve means for intercepting liquid, from an upward orientation to a downward orientation, simultaneously and progressively taking said intercepting means from a closed position to an open position, so as to allow the discharge of said liquid through said intercepting means and said tube.

Further characteristics and advantages of the invention shall become clearer from the description of a preferred but not exclusive embodiment of the device and procedure for discharging a cooking liquid from a food product cooking apparatus according to the finding, illustrated for indicating and not limiting purposes in the attached drawings, in which:

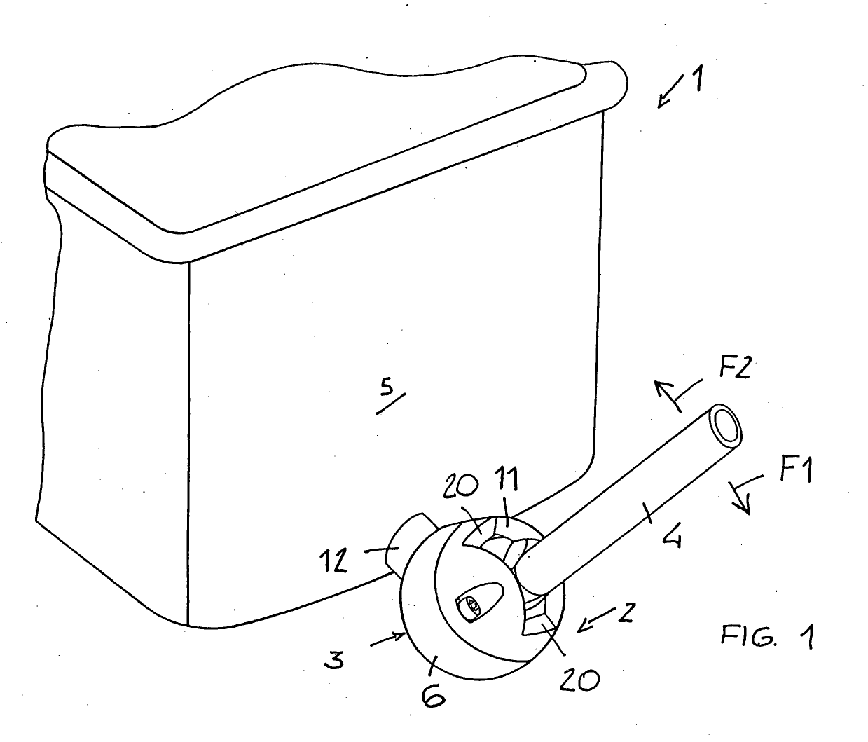

FIG. 1 shows a perspective view of a cooking apparatus like a fryer equipped with a discharging device according to the present finding;

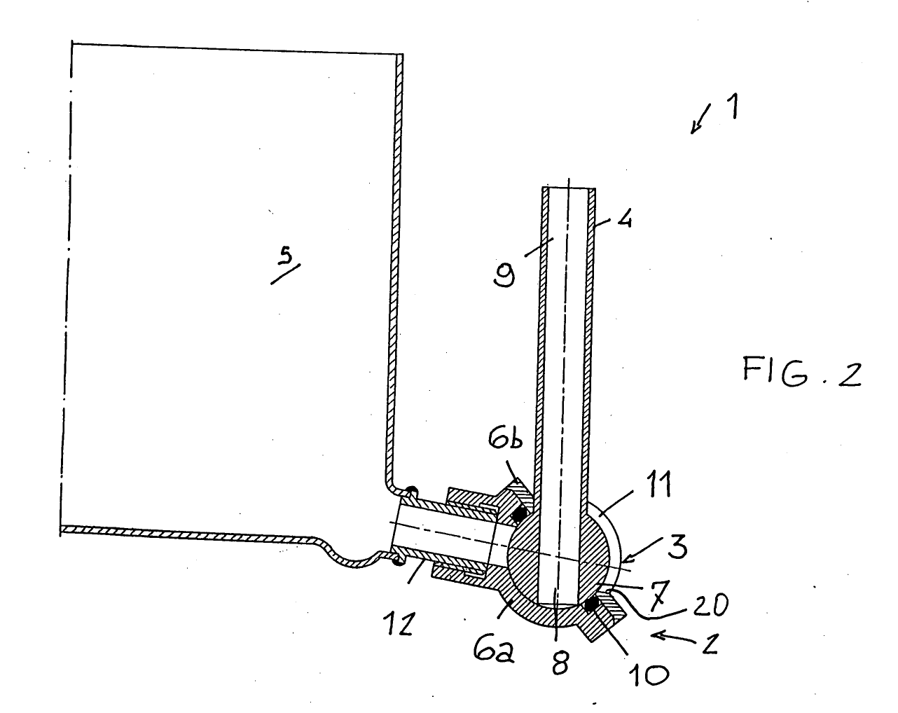

FIG. 2 shows a cross section of the discharging device of FIG. 1 in closed configuration; and

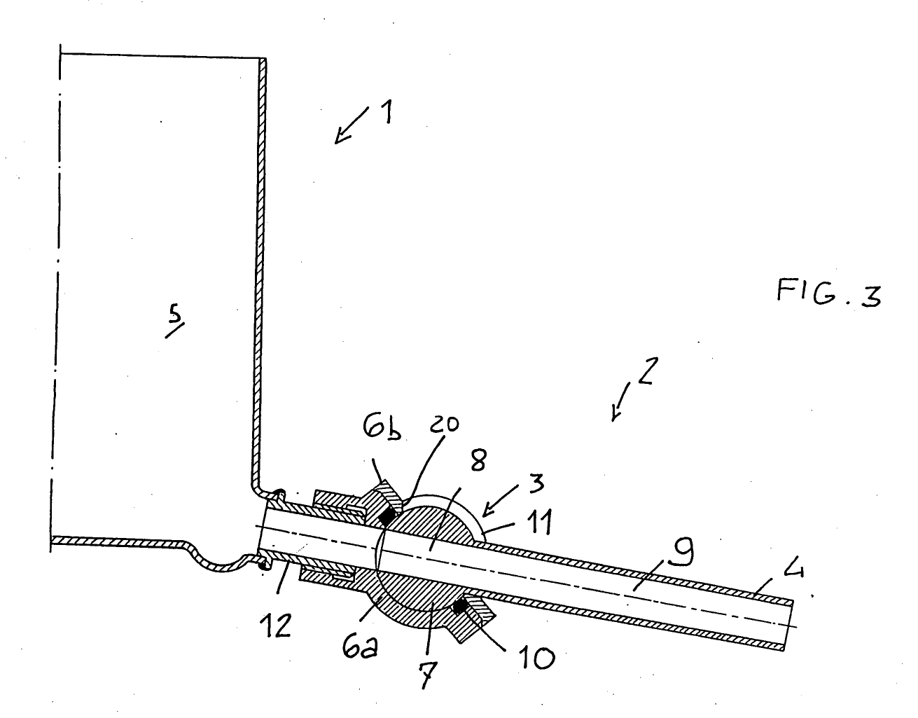

FIG. 3 shows a cross section of the discharging device of FIG. 1 in open configuration.

With reference to the quoted figures, an apparatus for cooking food products is shown, wholly indicated with reference-numeral 1.

The apparatus 1 consists of a fryer but, in other examples, can be an electric pasta cooking device or a rice cooker.

The apparatus 1 has, connected to a lower portion thereof, a device 2 for discharging a cooking liquid for food products. The discharging device comprises valve means 3 for intercepting the liquid and outside conveyance means 4 of the apparatus.

The intercepting valve means 3 are placed between the conveyance means 4 and a bowl 5 of the device 1 containing the cooking liquid.

In a preferred embodiment the intercepting valve means can be partialised and comprise a body 6 connected to the bowl 5 and defining a seat in which a hollow shutter 7 is connected, mobile between an open position (shown in FIG. 3) and a closed position (shown in FIG. 2).

Advantageously, the conveyance means 4 comprise a substantially rigid tube which is connected to the shutter 7, a recess 8 of the shutter being aligned to a recess 9 of the tube 4.

Suitably, in the open position the tube 4 is substantially vertical or tilted upwards and in the closed position the tube 4 is tilted downwards.

As shown in the attached figures, the body 6 is realised in two portions 6a, 6b connected together with the interposition of a gasket 10, with the portion 6b which has a groove 11 in which the tube 4 is slidably housed and which limits the displacement through two tilted walls 20.

Moreover, the discharging device 2 comprises a tubular connection element 12 placed between the bowl 5 and the body 6 of the valve means; appropriately, the connection element is tilted downwards.

The operation of the device for discharging a cooking liquid from a food product cooking apparatus according to the invention is clear from that which has been described and illustrated and, in particular, is substantially the following.

When one wants to discharge the cooking liquid like, for example, the oil of a fryer from the bowl 5, the tube 4 lowers as indicated by the arrow F1.

The lowering of the tube 4 causes the rotation of the shutter 7 in its seat and, therefore, the progressive alignment of its recess 8 with the recess of the tube 12 allowing the oil to go out.

Advantageously, if the tube is only partially rotated, without taking the shutter in perfect alignment with the recess of the tube 12, the flow of oil discharged can be partialised.

To take the tube back into rest position it is sufficient to rotate it as indicated by the arrow F2 up to vertical position.

Preferably, the tilted walls 20 of the groove 11 also constitute the end stops for the rotation of the tube 4 and define the closed position (with the tube 4 vertical) and the open position (with the tube 4 tilted downwards).

The present finding also refers to a procedure for discharging a cooking liquid such as oil from a food product cooking apparatus such as a fryer.

The procedure consists of rotating the substantially rigid tube 4, connected to the valve means 3 for intercepting the liquid, from an upward orientation to a downward orientation, simultaneously and progressively taking the intercepting means 3 from a closed position to an open position, so as to allow the discharge of the liquid through the intercepting means 3 and the tube 4.

In practice, it has been noted how the device and procedure for discharging a cooking liquid from a food product cooking apparatus according to the invention are particularly advantageous because they are particularly safe and reliable. The device and procedure for discharging a cooking liquid from a food product cooking apparatus thus conceived are susceptible to numerous modifications and variants, all covered by the inventive concept; moreover, all of the details can be replaced with technically equivalent elements. In practice, the materials used, as well as the sizes, can be whatever according to the requirements and the state of the art.

1. Device for discharging a cooking liquid from a food product cooking apparatus, characterised in that it comprises valve means for intercepting said cooking liquid and outside conveyance means of said apparatus.

2. Discharging device according to claim 1, characterised in that said intercepting valve means are placed between said conveyance means and a bowl of said device containing said cooking liquid.

3. Discharging device according to claim 1, characterised in that said intercepting valve means can be partialised.

4. Discharging device according to claim 2, characterised in that said intercepting valve means comprise a body connected to said bowl and defining a seat in which a hollow shutter is rotatably connected, mobile between an open position and a closed position.

5. Discharging device according to claim 1, characterised in that said conveyance means comprise a substantially rigid tube.

6. Discharging device according to claim 2, characterised in that said substantially rigid tube is connected to said shutter, a recess of said shutter being aligned to a recess of said tube.

7. Discharging device according to claim 2, characterised in that in said open position said tube is substantially vertical or tilted upwards and in said closed position said tube is tilted downwards.

8. Discharging device according to claim 2, characterised in that it comprises a tubular connection element placed between said bowl and said body of said valve means, said connection element being tilted downwards.

9. Procedure for discharging a cooking liquid from a food product cooking apparatus, characterised in that it consists of rotating a substantially rigid tube, connected to valve means for intercepting liquid, from an upward orientation to a downward orientation, simultaneously and progressively taking said intercepting means from a closed position to an open position, so as to allow the discharge of said liquid through said intercepting means and said tube.

10. Discharging device and procedure according to claim 2, characterised in that said food product cooking apparatus is a fryer and said liquid to be discharged is oil.

11. Device and procedure for discharging a cooking liquid from a food product cooking apparatus, all as substantially described, represented in the attached tables of drawings and claimed.
